(19) United States
(12) Patent Application Publication
(10) Pub. No.: US 2015/0081754 A1
(43) Pub. Date: Mar. 19, 2015

(54) NUMERICAL ALGORITHM FOR NTH ROOT

(71) Applicants: Natarajan Murugesan, Toronto (CA); Ramasamy Ayyathurai, Pondicherry (IN)

(72) Inventors: Natarajan Murugesan, Toronto (CA); Ramasamy Ayyathurai, Pondicherry (IN)

(21) Appl. No.: 13/261,820

(22) PCT Filed: Nov. 11, 2011
(86) PCT No.: PCT/IB2011/002671

§ 371 Date: Aug. 4, 2014

(51) Int. Cl. G06F 17/10

(52) U.S. Cl. CPC G06F 17/10
USPC 708/605

(57) ABSTRACT

Presently a direct analytical method, vide the Babylonian method developed in 1800 B.C., is available for the digit-by-digit extraction of the square root of a given positive real number. To calculate the n^{th} root of a given positive real number one may use trial and error method, iterative method, etc. When one desires to determine the n^{th} root, it is found that such methods are inherent with certain weaknesses like the requirement of an initial guess, a large number of arithmetic operations and several iterative steps for convergence, etc. There has been no direct method for the determination of the n^{th} root of a given positive real number. This paper focuses attention on developing a numerical algorithm to determine the digit-by-digit extraction of the n^{th} root of a given positive real number up to any desired accuracy. The analytic method contained in this paper would enable one to carry out digit-by-digit extraction of the n^{th} root of a given positive real number which can be directly implemented. Since it is computationally feasible, it may be built in electronic devices to determine the n^{th} root of a given positive real number.

### 1. INTRODUCTION

Let n be any natural number>1. Certain methods are currently available to find real positive n^{th} root of a given positive real number. Historically speaking, the Babylonian method was developed in 1800 B.C. for the extraction of the square root of a number. One can apply the concept of logarithm introduced by Napier [1(a), (b)] to evaluate the root. However the logarithmic method does not yield accurate results due to truncation errors. It is observed that the conventional long-division square root method is accurate. An algorithm for finding the square root of a number has been described by R. G. Dromey in [2]. For the approximation of quadratic irrationals by rationals and the application of Pell's equation for the extraction of square root, one may refer Niven and Zuckerman [3]. For the determination of cube root, fourth root, etc., of a given number, one may employ an appropriate numerical method, for e.g, Newton's method. Determination of the n^{th} root reduces to solving a non-linear equation of a single variable for which the methods available may be categorized as direct analytical method, graphical method, trial and error method, iterative method, etc. Gower [4] has described an iterative method for the determination of roots. For the iteration methods like bisection method, false position method, Taylor series method, Newton-Raphson method, Muller's method, etc, one may see Burden and Faires [5]. These methods are inherent with certain weaknesses when one desires to utilize them for the extraction of the n^{th} root such as the requirement of an initial guess, a large number of arithmetic operations and several iterative steps for convergence, etc. For example, in Newton-Raphson method, a previously guessed value is required and an iterative method may not converge if the initial guess differs very much from the exact root. In [6] Matthews has discussed the computation of n^{th} root of positive integers. Newton's method in the extraction of n^{th} root has been demonstrated by Priestley [7]. An algorithm for finding the root with a five-function calculator employing logarithm has been furnished by Muench and Wildenberg in [8].

However, there is no direct analytical method for the extraction of the n^{th} root of a given number. Developing an algorithm to find the n^{th} root has remained an interesting and challenging problem. To mitigate the drawbacks in the existing methods, there is a crucial need to develop a new efficient method. Under this background, the present paper focuses attention on a computationally simple numerical algorithm for the digit-by-digit determination of the real positive n^{th} root of a given positive real number up to any desired accuracy, by introducing three functions Uᵢ, Vᵢ and Tᵢ and establishing a relationship involving them.

### 2. Number of Digits Due to Exponentiation

First we need a basic result for our algorithm. Let root N and W denote the sets of natural and whole numbers respectively. Let a be a given positive integer with k digits, k∈N. Let us consider the number of digits occurring while a is raised to n^{th} power.

Theorem 1 Step 2

If m denotes the number of digits in aⁿ then

(k−1)n+1≦m≦kn, for all n, k∈N. (2.1)

### Proof

Case (i) First let us consider n=2. If k=1, Then

$$m = \{ \begin{matrix}1 , for 1 \leq α \leq 3 \\ 2 , for 4 \leq α \leq 0\end{matrix} \qquad ( 2.2 )$$

If k>1, then we have

$$m = \{ \begin{matrix}2 k - 1 , & for {10}^{k - 1} \leq α \leq 3 ( {10}^{k - 1} ) \\ 2 k , & for 4 ( {10}^{k - 1} ) \leq α \leq {10}^{k} - 1\end{matrix} \qquad ( 2.3 )$$

and 2k−1≦m≦2k

for 3(10^{k-1})+1≦a≦4(10^{k-1})−1 (2.4)

Equations (2.2), (2.3) and (2.4) imply that (2.1) holds for n=2.

Case (ii) Next suppose that n>2. If k=1, then a<10 or aⁿ<10ⁿ. This implies that aⁿ contains utmost n digits.

### Therefore

1≦m≦n (2.5)

Consider a k-digit number a with k>1. Then we have 10^{k-1}≦a<10^{k}. Hence, 10^{(k-1)n}≦aⁿ<10^{kn}. This implies that

(k−1)n+1≦m≦kn (2.6)

Hence the equation (2.5) and (2.6) imply that (2.1) holds for n>2. Thus the theorem holds for all values of n, k∈N.

### 3. Numerical Algorithm

Suppose it is required to find the n^{th} root of a given positive integer M. First we present a method when M perfect n^{th} power of a positive integer. The general case is postponed to section 5.

### Step 1

Starting from the unit place of M, split the digits of M into a maximum possible number of blocks each of size n. In the process, if certain left most digits of M are still remaining, then form another block with these digits. Let the total number of blocks, so formed with the digits of M, be k. Then, by Theorem 1, the real positive n^{th} root of M consists of k-digits, say a₁, a₂, . . . , aₖ starting from the unit place of it.

Let us denote M by M(k, n). Then

M(k,n)=(10^{k-1}aₖ+10^{k-2}aₖ₋₁+ . . . +a₁)ⁿ (3.1)

Name the blocks of M(k, n), starting from the right of M(k, n), as B₁, B₂, . . . , Bₖ. Let |Bᵢ| denote the size of Bᵢ. Then

|Bᵢ|=n, for i=1, 2, . . ., k−1 (3.2)

and 1≦|Bₖ≦n (3.3)

Determine the maximum possible value of aₖ∈N such that

(aₖ)ⁿ≦Bₖ (3.4)

Let Rₖ=aₖ (3.5)

If k=1, then Rₖ gives the required real positive n^{th} root of M(k, n). If k≠1, then go to step 2.

### Step 2

Form the block Dₖ=Bₖaₖⁿ (3.6)

Define Mₖ₋₁ such that

Mₖ₋₁=M(k,n)−10⁽k−1)aₖⁿ (3.7)

Let Uₖ=aₖ (3.8)

and Vₖ=0 (3.9)

Starting from the unit place of Mₖ₋₁, split the digits of Mₖ₋₁ into (k−2) blocks each of size n and from another block with remaining left most digits of Mₖ₋₁. Denote the left most block of Mₖ₋₁ by Bₖ₋₁(Mₖ₋₁). Then we have

Bₖ₋₁(Mₖ₋₁)=Dₖ·Bₖ₋₁ (3.10)

where Dₖ·Bₖ₋₁ is defines as the concatentation (denoted by ‘·’) of Dₖ and Bₖ₋₁.

Take Uₖ₋₁=10(UₖVₖ) (3.11)

Determine the maximum value of Vₖ₋₁∈W such that

$$\begin{matrix}{V}_{k - 1} {T}_{k - 1} \leq {B}_{k - 1} ( {M}_{k - 1} ) & ( 3.12 ) \\ where \\ {T}_{k - 1} = {\sum }_{r = 1}^{n} ( \begin{matrix}n \\ r\end{matrix} ) {U}_{k - 1}^{n - r} {V}_{k - 1}^{r - 1} \\ and \\ ( \begin{matrix}n \\ r\end{matrix} ) & ( 3.13 )\end{matrix}$$

denotes the number of combinations of n objects taken r at a time.

Let aₖ₋₁=Vₖ₋₁ (3.14)

Define Rₖ₋₁=RₖoVₖ₋₁ so that

Rₖ₋₁=10aₖ+aₖ₋₁ (3.15)

If k=2, then Rₖ₋₁ is the required root. If k≠2, then go to step 3.

### Step 3

Define Mₖ₋₂=Mₖ₋₁−10^{(k-2)n}Vₖ₋₁Tₖ₋₁ (3.16)

Repeat the process as in step 2, where Mₖ₋₂ consists of (k−2) blocks.

Find Uₖ₋₂ and Vₖ₋₂ by following the similar procedures in equations (3.11) and (3.12) respectively. Let aₖ₋₂=Vₖ₋₂ and define Rₖ₋₂, etc., in a similar way. Repeat the process until k reduces to 1. Now R₁=10^{k-1}aₖ+10^{k-z}aₖ₋₁+ . . . +a₁ is the n^{th} root of M.

### 4. Proof of the Method

We shall validate the method presented in section 3, by the principle of mathematical induction.

### Lemma 1

1≦aₖ≦9

### Proof

Using (3.3) and (3.4), we obtain aₖⁿ≦Bₖ<10ⁿ. Hence aₖ10. aₖ≦1, since Bₖ≠0 which imply that 1≦aₖ9.

### Lemma 2

0≦aᵢ≦9, i=1,2, . . . , k−1.

### Proof

Employing (3.6) we get 10ⁿ Dₖ=10ⁿ Bₖ−10ⁿaₖⁿ. It follows that 10ⁿ aₖⁿ+10ⁿ Dₖ+Bₖ₋₁=10ⁿ Bₖ+Bₖ₋₁. Using (3.8) and (3.10) we get 10ⁿ Uₖⁿ+Bₖ₋₁(Mₖ₋₁)=Bₖ·Bₖ₋₁. Because of (3.12) this relation implies that 10ⁿ Uₖⁿ+Vₖ₋₁ Tₖ₋₁≦BₖoBₖ₋₁. In view of (3.2) and (3.3) we obtain |10^{k} Uₖⁿ+Vₖ₋₁ Tₖ₋₁|≦2n. Now (3.9) and (3.11) imply that |Uₖ₋₁ⁿ+Vₖ₋₁ Tₖ₋₁|≦2n. Using Binomial theorem, we get |(Uₖ₋₁+Vₖ₋₁ Tₖ₋₁|≦2n. Therefore |(10 Uₖ+Vₖ₋₁)ⁿ|2n.

In view of Uₖ=aₖ≠0 and the maximum choice of aₖ, by Theorem 1 it follows that 0≦Vₖ₋₁≦9. Using (3.14) we obtain 0≦aₖ₋₁≦9.

Similarly we can prove that 0≦aᵢ≦9, i=1, 2, . . . , k−2.

Let M(k, 11) be the perfect n^{th} power of a positive integer, say λ. Then

M(k, n)=λⁿ (4.1)

where λ=10^{k-1} aₖ+10^{k-2} aₖ₋₁+ . . . +a₁, using (3.1).

From equations (3.11) and (3.14) and step 3 of the algorithm it follows that

$$\begin{matrix}{V}_{i} = {a}_{i} , & i = 1 , 2 , … , k - 1 \\ {U}_{i} = 10 ( {U}_{i + 1} + {V}_{i + 1} ) , & i = 1 , 2 , … , k - 1\end{matrix} \} \qquad ( 4.2 )$$

Equation (3.13) and step 3 of algorithm imply that

$${T}_{i} = {\sum }_{r = 1}^{n} ( \begin{matrix}n \\ r\end{matrix} ) {U}_{i}^{n - r} {V}_{i}^{r - 1} , i = 1 , 2 , … , k - 1 \qquad ( 4.3 )$$

It is seen that

Uᵢ=Σⱼ₌ᵢ₊₁^{k}aⱼ10^{j-i}, i=1, 2, . . . , k−1 (4.4)

from equations (3.8), (3.9) and (3.11) and step 3 of algorithm. For i=1, 2, . . . , k−2, step 3 and equations (3.7) and (3.16) imply that Mᵢ=M(k, n)−{aₖⁿ 10^{(k-1)n}+Σⱼ₌ᵢ₊₁^{k-1}Vⱼ Tⱼ 10^{(j-1)n}.}

From equations (3.5) and (3.15) and step 3, we obtain RᵢΣⱼ₌ᵢ^{k} aⱼ 10^{j-1}, i=1, 2, . . . , k.

For i=1, 2, . . . , k−1, relation (4.4) implies that Uᵢ=10Σⱼ₌ᵢ₊₁^{k} aⱼ 10^{j-(i+1)}=10 R_{i+1. Hence from equations (}3.8), (3.9) and (3.11) and step 3 of the algorithm we obtain Uᵢ=10, Rᵢ₊₁, i=1, 2, . . . k−1. For i=1, 2, . . . , k−2, step 3 and equations (3.7) and (3.16) imply that Mᵢ=M(k,n)−{aₖⁿ 10^{(k-1)n}+Σⱼ₌ᵢ₊₁^{k-1} Vⱼ Yⱼ 10^{(j-1)n}}.

From equations (3.5) and (3.15) and step 3, we get Rᵢ=Σⱼ₌ᵢ^{k} aⱼ 10^{j-i}, i=1, 2, . . . , k.

For i=1, 2, . . . , k−1, relation (4.4) implies that Uᵢ=10 Σⱼ₌ᵢ₊₁^{k} aⱼ 10^{j-(i+1)}=10 Rᵢ₊₁. Hence Uᵢ=10 Rᵢ₊₁, i=1, 2, . . . , k−1.

### Theorem 2

Given n∈N, the Uᵢ(i=1, 2, . . . , k), Vᵢ (i=1, 2, . . . , k) and Tᵢ (i=1, 2, . . . , k−1) satisfy the relation

Uₖⁿ10^{(k-1)n}+Σᵢ₌₁VᵢTᵢ10⁽ⁱ⁻¹⁾ⁿ=M(k,n) (4.5)

for all k∈N.

### Proof

From (3.1), it is seen that the relation (4.5) holds for k=1.

Assume that the relation (4.5) holds for k∈N. Let us consider M(k+1, n). Then the relations (3.8), (3.9), (4.2) and (4.3) hold with k increased by 1.

Now Uₖ₊₁ⁿ 10^{kn}+Σᵢ₌₁^{k}VᵢTᵢ10⁽ⁱ⁻¹⁾ⁿ=Uₖ₊₁ⁿ10^{kn}+Σᵢ₌₂VᵢTᵢ10⁽ⁱ⁻¹⁾ⁿ+V₁T₁=(Uₖ₊₁ⁿ 10^{(k-1)n}+Σᵢ₌₂^{k}VᵢTᵢ10⁽ⁱ⁻²⁾ⁿ⁾10ⁿ+V₁T₁=(10^{k-1}aₖ₊₁+10^{k-2}aₖ+ . . . +a₂)ⁿ10ⁿ+V₁T₁ by using induction assumption for Uᵢ(i=2, 3, . . . , k+1), Vᵢ(i=2, 3, . . . , k+1) and Tᵢ(i=2, 3, . . . , k).

Hence

Uₖ₊₁ⁿ10^{k,n}+Σᵢ₌₁^{k}VᵢTᵢ10⁽ⁱ⁻¹⁾ⁿ=(10^{k}aₖ₊₁+10^{k-1}aₖ+ . . . +10a₂)ⁿ+V₁T₁ (4.6)

Using the relation (4.5) applicable for (k+1), the right side of (4.6) becomes

$$\begin{matrix}{U}_{1}^{n} + {V}_{1} {T}_{1} = {U}_{1}^{n} + {V}_{1} [ ( \begin{matrix}n \\ 1\end{matrix} ) {U}_{1}^{n - 1} + ( \begin{matrix}n \\ 2\end{matrix} ) {U}_{1}^{n - 2} {V}_{1} + … + ( \begin{matrix}n \\ n\end{matrix} ) {V}_{1}^{n - 1} ] \\ = {( {U}_{1} + {V}_{1} )}^{n} ,\end{matrix}$$

using Binomial theorem=(10^{k}aₖ₊₁+10^{k-1}aₖ+ . . . +10a₂+a₁)ⁿ which yields M(k+1, n). Hence the theorem follows by induction of k.

### 5. nthe Root in General Case

In general one may require to find the n^{th} root of a positive integer, which may not be a prefect n^{th} power of n^{th} root of a positive real number. Then the algorithm presented in section 3 has to be adopted with certain modifications as indicated below.

Let M be a positive real number. It may consist of integral and decimal parts. Suppose that the root is required upto h places of decimals. Then multiply the given number M by 10^{hn} and follow the algorithm in section 3 for [10^{kn}M], wherein R₁ would be the integral part of the n^{th} root of 10^{kn}M. Now divide R₁ by 10^{h} to obtain the n^{th} root of M up to h places of decimals, since

$$\sqrt[n]{M} = \frac{1}{{10}^{h}} \sqrt[n]{{10}^{hn} M} .$$

Let us take some examples.

5.1 Case M is a Perfect n^{th} Power

### EXAMPLE 1

Find

$$\sqrt[3]{16457616482180544} .$$

### Step 1

Let M=16457616482180544. Since n=3 split the digits of M as described in section 3. We have

$$\begin{matrix}{B}_{6} & {B}_{5} & {B}_{4} & {B}_{3} & {B}_{2} & {B}_{1} \\ 16 & 457 & 616 & 482 & 180 & 544\end{matrix}$$

where k=6. We assert that a₆=2 is the maximum value such that a₆²≦16. It is seen that R₆=a₆=2. Since k≠1, go to step 2.

### Step 2

Form the block D₆=B₆−a₆³=8. Define M₅=M−10^{5·3}a₆³=8 457 616 482 180 544. Let U₆=a₆=2 and V₆=0. It is seen that B₅(M₅)=D₆·B₅=8457.

Split the digits of M₅ as

$$\begin{matrix}{B}_{5} ( {M}_{5} ) & {B}_{4} & {B}_{3} & {B}_{2} & {B}_{1} \\ 8457 & 616 & 482 & 180 & 544\end{matrix}$$

### Step 3

Take U₅=10 (U₆+V₆)=20. Assigning the values of 0, 1, 2, 3, 4, 5 and 6 to V₅, we get V₅ T₅=0, 1261, 2648, 4167, 5824, 7625 and 9576 respectively, where

$${T}_{5} = {\sum }_{r = 1}^{3} ( \begin{matrix}3 \\ r\end{matrix} ) {U}_{5}^{3 - r} {V}_{5}^{r - 1} .$$

Hence the maximum value of V₅∈W, such that V₅T₅≦8457, is 5 where T₅=1525. Let aₛ=V₅=5 and R₅=10 a₆+a₅=25.

For the subsequent steps, the results are presented in the following table.

| i | Mᵢ | Uᵢ | Bᵢ(Mᵢ) | Vᵢ | Tᵢ | VᵢTᵢ | aᵢ | Rᵢ |
|---|---|---|---|---|---|---|---|---|
| 4 | 832616482180544 | 250 | 832616 | 4 | 190516 | 762064 | 4 | 254 |
| 3 | 70552482180544 | 2540 | 70552482 | 3 | 19377669 | 58133007 | 3 | 2543 |
| 2 | 12419475180544 | 25430 | 12419475180 | 6 | 1940512476 | 11643074856 | 6 | 25436 |
| 1 | 776400324544 | 254360 | 776400324544 | 4 | 194100081136 | 776400324544 | 4 | 254364 |

Hence R₁=10⁵a₆+10⁴a₅+10²a₄+10²a₂10a₁₊ₐ₁=254364 is the cube root of M. It is seen that U₆²10^{5·2+Σ}ᵢ₌₁⁵VᵢTᵢ10⁾ⁱ⁻¹⁾⁻²=254364²=M.

### EXAMPLE 2

Find

$$\sqrt[4]{16192865729295} .$$

For a given problem, the above stepwise procedure can be followed. However, for a simpler presentation, another procedure may prove handy, as illustrated in the following example.

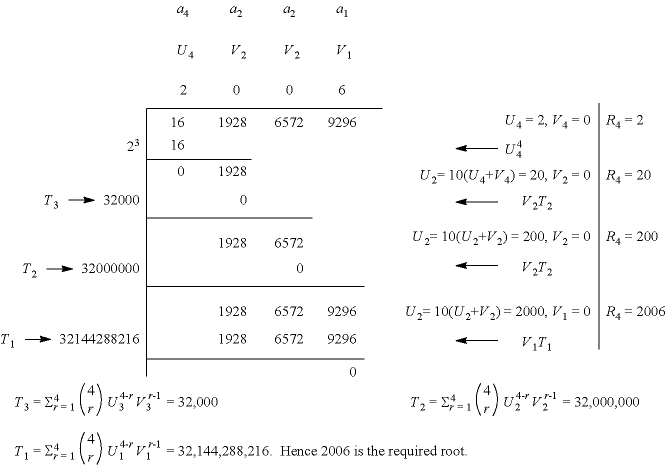

### 5.2 Case M is Not a Perfect nth Power

### EXAMPLE 3.

Find

$$\sqrt[4]{175}$$

correct to two places of decimals.

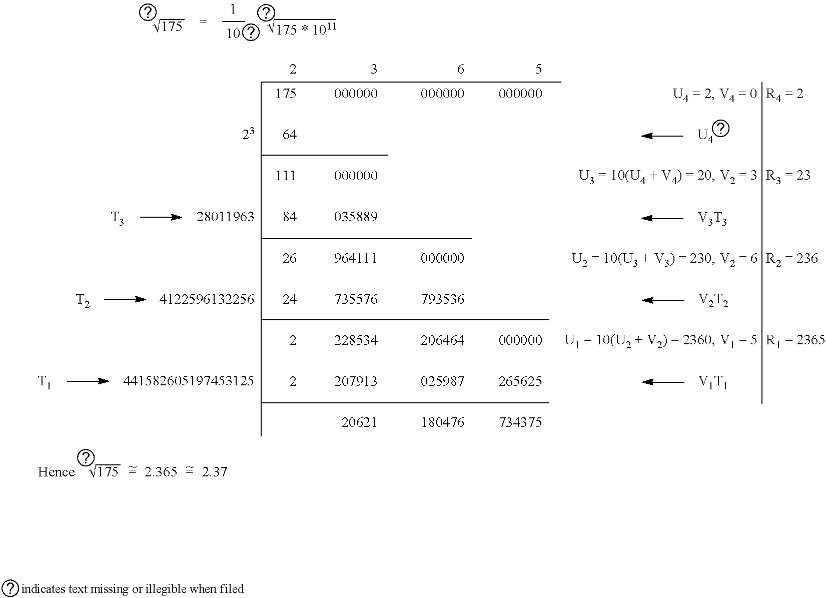

### EXAMPLE 4

Find

$$\sqrt[3]{35.66 …}$$

correct to three places of decimals.

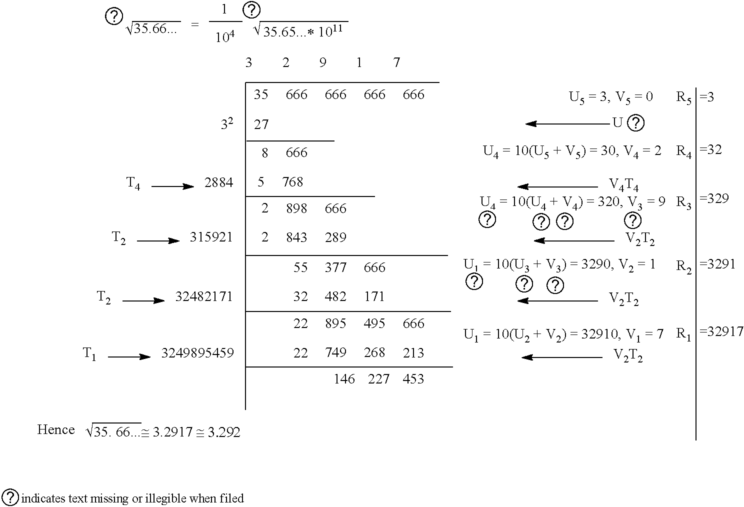

### 6. CONCLUSION

The analytic method contained in this paper would enable one to carry out digit-by-digit extraction of the n^{th} root of a given positive real number which can be directly implemented. When one uses Newton's method for the determination of the n^{th} root, he shall find out an initial solution and then he has to resort to differentiation. On the other hand, the method presented in this paper uses simple arithmetic operations only and an initial solution is not necessary. Since it is computationally feasible, it may be built in electronic devices to determine the n^{th} root of a given positive real number without demanding more of memory space.

### ACKNOWLEDGEMENT

The authors sincerely thank the referee for the several suggestions towards the improvement of the paper.

### REFERENCES

[1] (a) J. Napier, Mirifici Logarithmorum Canonis Descriptio (1614) and E. Wright (English Translation from Latin), A Description of the Admirable Table of Logarithms (1616).
(b) J. Napier (1969), A Description of the Admirable Table of Logarithms, London 1616, Amsterdam; New York, N.Y.: Theatrum Orbis Terrarum; Da Capo Press.
[2] R. G. Dromey, How to solve it by computer, Pearson Education, New Delhi, 2008.
[3] I. Niven and H. Zuckerman, An introduction to the theory of numbers, Wiley Student Edition, New Delhi, 1991.
[4] J. Gower, A note on an iterative method for root extraction, The Computer J., 1(3) (1958), 142-143.
[5] R. Burden and D. Faires, Numerical analysis, Thomson Asia, Bangalore, 2005.
[6] K. Matthews, Computing m^{th} roots, The College Math. J., 19 (1988), 174-176.
[7] W. Priestley, From square roots to n^{th} roots, Newton's method in disguise, The College Math. J., 30:5 (1999), 387-388.
[8] D. Muench and G. Wildenberg, A logarithm algorithm for a five-function calculator, The Two-year College Math. J., 14 (4) (1983), 324-326.

1. The algorithm for nth root described in the published paper can be embedded in the electronic machines such as calculators, computers, etc., to solve the problems of nth root of positive real numbers up to any desired accuracy.
